(19) United States
(12) Patent Application Publication
(10) Pub. No.: US 2016/0311078 A1
(43) Pub. Date: Oct. 27, 2016

(54) Dust Bag Insert

(71) Applicant: Dariusz Kalat, Harwood Heights, IL (US)

(72) Inventor: Dariusz Kalat, Harwood Heights, IL (US)

(21) Appl. No.: 15/134,601

(22) Filed: Apr. 21, 2016

Related U.S. Application Data
(60) Provisional application No. 62/150,362, filed on Apr. 21, 2015.

(51) Int. Cl. B24B 55/10; B01D 46/02

(52) U.S. Cl. CPC B24B 55/10; B01D 46/02

(57) ABSTRACT

A dust bag insert. The dust bag insert is sized and shaped to conform to a sanding machine dust bag and serve as a removable receptacle therein. The dust bag insert includes a body having an interior volume configured to receive particulate matter generated by a sanding machine. The body includes a lower end and an upper end having a neck with an opening. The body is constructed of a material having a porosity configured to prevent the particulate matter from passing therethrough. The neck is configured to surround a sanding machine's exhaust pipe when affixed thereto. In this way, the dust bag insert, instead of the dust bag, collects the particulate matter generated by the sanding machine. The dust bag insert can be removed and disposed of once filled, thereby preventing the escape of particulate matter into the ambient environment when emptying the sanding machine bag.

### CROSS REFERENCE TO RELATED APPLICATIONS

This application claims the benefit of U.S. Provisional Application No. 62/150,362 filed on Apr. 21, 2015. The above identified patent application is herein incorporated by reference in its entirety to provide continuity of disclosure.

### BACKGROUND OF THE INVENTION

The present invention relates to dust bag inserts. More specifically, the present invention relates to a dust bag insert sized and shaped to be inserted into conventional sanding machine dust bags in order to collect sanded wood and other particulate matter filtered into the sanding machine dust bags. The dust bag insert facilitates the disposal of this particulate matter and the prevention of the same from spilling and escaping into the ambient environment.

Sanding machines or sanders are commonly used to smooth surfaces such as floors and are capable of removing layers of surfaces that are composed of wood or wood materials. For instance, floor sanders can be employed to polish the top surface of a wood floor and create a smooth finish thereon, or to remove a previous floor covering, such as a varnish, in order to reveal a wood surface or other surface thereunder.

Sanders contain a vacuum system having a filter or dust bag configured to collect the dust particles and other particulate matter produced by the sanding process. These dust bags are generally composed of fabric and are intended to be reused throughout the life of the sander. These dust bags are problematic because they often allow fine particulate matter created by the sanding process to escape through the bag into the environment. Furthermore, the amount of particulate matter escaping through the dust bags increases as the dust bags wear over time. Moreover, these dust bags must be emptied when full. Such emptying is not easily accomplished as it requires the direct dumping of the dust from the bag into a waste receptacle, causing the dust and other particulate matter to escape into the ambient environment. Such particulate matter can be dangerous to a person's respiratory health and can also settle and collect on various surfaces requiring additional cleaning and sanitization.

Existing devices fail to provide a dust bag insert sized and shaped to be inserted into conventional sanding machine bags. Therefore, the dust bags themselves must be disposed of or must be emptied by dumping the dust or wood particulates collected therein into a waste receptacle, which increases the potential spillage and spread of the particulate matter into the ambient environment. Therefore, a dust bag insert sized and shaped to be inserted into conventional sanding machine bags is desired.

### SUMMARY OF THE INVENTION

In view of the foregoing disadvantages inherent in the known types of dust bags now present in the prior art, the present invention provides a dust bag insert wherein the same can be utilized for providing convenience for the user when disposing the dust and particulate matter collected while using a sanding machine. The present invention comprises a dust bag insert sized and shaped to be inserted into a sanding machine dust bag and serve as a removable receptacle therein. The dust bag insert comprises a body having an interior volume configured to receive and sustain particulate matter, wherein the body is composed of a flexible plastic material having a porosity configured to prevent the particulate matter from escaping therethrough into the ambient environment. The body further comprises a closed lower end and an upper end having an elongated neck with an opening for providing access to the interior volume. The elongated neck is sized to fit and extend through a collar of the sanding machine dust bag, such that the elongated neck may removably surround the exhaust pipe of a sanding machine. In operation, the dust bag insert is inserted into a conventional sanding machine dust bag, the elongated neck is extended through the sanding machine dust bag, and the sanding machine dust bag is mounted onto the sanding machine, ensuring that the elongated neck surrounds the exhaust pipe. In this way, the dust bag insert, instead of the actual sanding machine dust bag, collects the particulate matter formed by the sanding machine and facilitates the disposal of the particulate matter.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the dust bag insert.

FIG. 2 shows a perspective view of the dust bag insert as inserted into a conventional sanding machine dust bag.

FIG. 3 shows a perspective view of the dust bag insert in use.

FIG. 4 shows a perspective view of the dust bag insert being removed from a conventional sanding machine dust bag.

### DETAILED DESCRIPTION OF THE INVENTION

Reference is made herein to the attached drawings. Like reference numerals are used throughout the drawings to depict like or similar elements of the dust bag insert. The figures are intended for representative purposes only and should not be considered to be limiting in any respect.

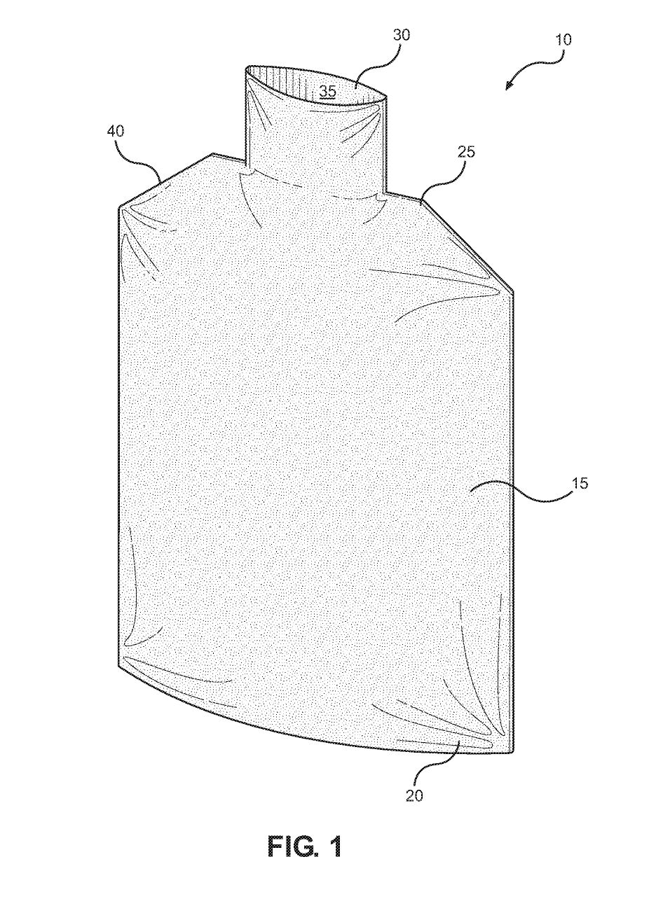

Referring now to FIG. 1, there is shown a perspective view of the dust bag insert. The dust bag insert 10 comprises a body 15 configured to be inserted into a conventional sanding machine dust bag and serve as a receptacle therein. The body 15 comprises an interior volume configured to receive and sustain particulate matter, such as wood, wood materials, and varnish formed by a sander. The body 15 is substantially rectangular in shape and comprises a closed lower end 20 and an upper end 25 having an elongated neck 30 with an opening for providing access to the interior volume of the body 15. In the depicted embodiment, the upper end 25 comprises angled sides 40 so that the dust bag insert 10 matches the shape and dimensions of a conventional sanding machine bag.

The body 15 is constructed of a flexible plastic material having a porosity configured to prevent the particulate matter from passing therethrough, thereby trapping the particulate matter within the interior volume of the body 15 and preventing its escape into the ambient environment. In some embodiments of the present dust bag insert, the body 15 is constructed from polypropylene plastic, polyethylene, polycarbonate, polyvinyl chloride, or any combination thereof. In alternative embodiments, the body 15 is further defined by two planar members or layers, wherein each layer has edges that are joined via stitching or an adhesive. The elongated neck 30 extends upwardly from the upper end 25 of the body 15 and is configured to receive an exhaust pipe of a sanding machine therein. In one embodiment, the elongated neck 30 includes an interior surface 35 having an adhesive layer configured to seal the opening of the elongated neck 30 when pressed together and/or removably attach the elongated neck 30 to the surface of an exhaust pipe of a sanding machine.

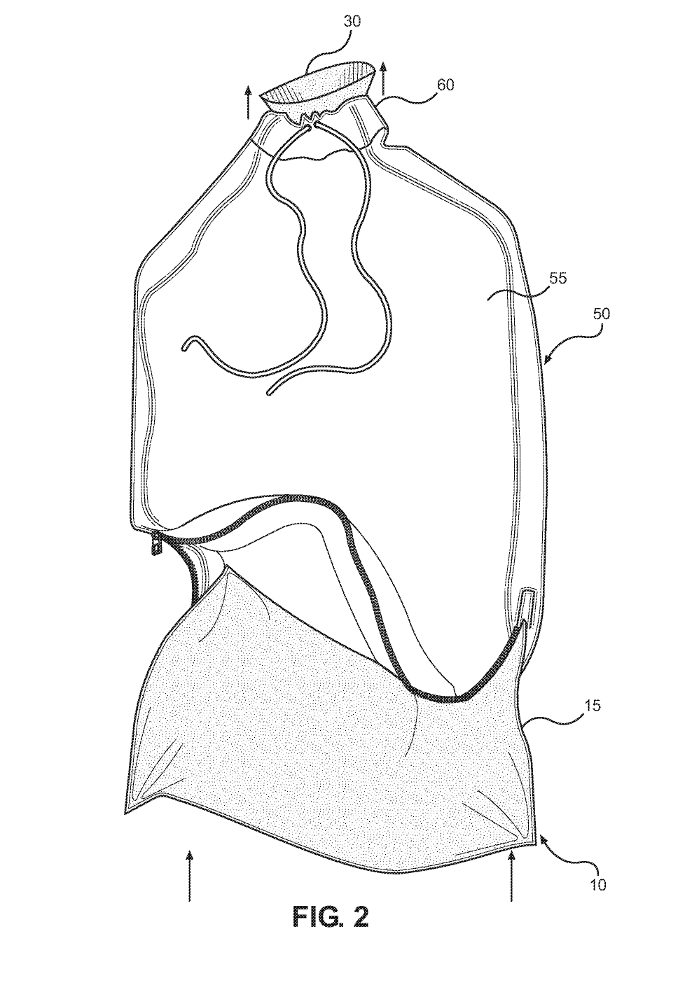

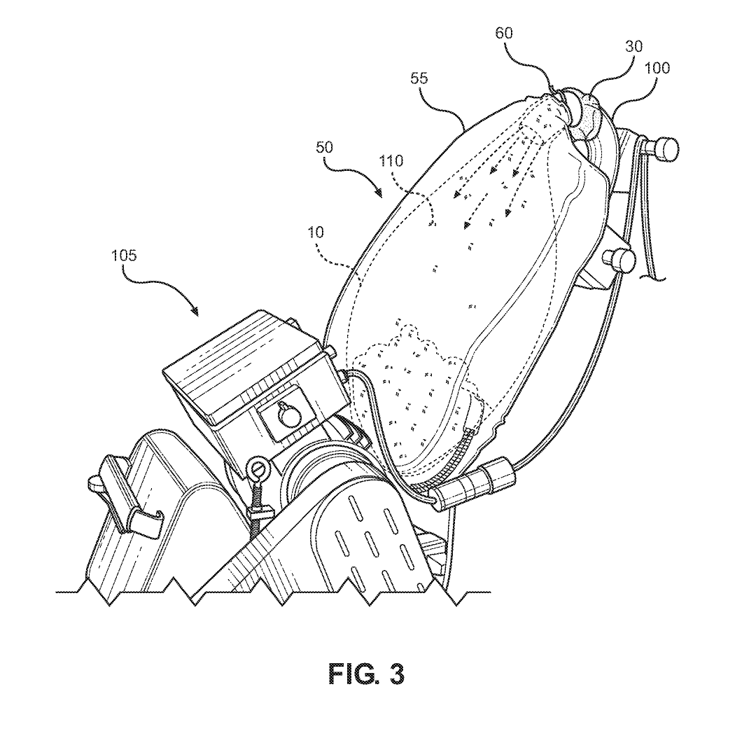

Referring now to FIGS. 2 and 3, there is shown a perspective view of the dust bag insert as inserted into a conventional zippered cloth sanding machine dust bag and a view of the dust bag insert in use, respectively. The dust bag insert 10 is sized and shaped to be inserted into a conventional sanding machine dust bag 50. The size and shape of the dust bag insert 10 enables the dust bag insert 10 to be close-fitting with the interior volume of the dust bag 50, such that it occupies the same and expands in conjunction with the interior volume of the dust bag 50. Further, the dust bag insert body 15 has dimensions equal to a close tolerance of the dimensions of the body 55 of the sanding machine's dust bag 50, thereby enabling it to conform to the interior of the dust bag 50. The elongated neck 30 of the dust bag insert 10 is configured to extend through the collar 60 of the sanding machine dust bag 50, such that when the collar 60 of the sanding machine dust bag 50 is fastened to an exhaust pipe of a sander, the elongated neck 30 surrounds the opening of the exhaust pipe 100 entirely, preventing the escape of particulate matter into the ambient environment when in use.

In operation, the dust bag insert 10 is led through a zippered opening at the bottom of an embodiment of a sanding machine dust bag 50 or inserted through the collar 60 of the sanding machine dust bag 50. The elongated neck 30 of the dust bag insert 10 is then pulled through the collar 60 of the sanding machine dust bag 50, such that it protrudes outwardly from the collar 60. Once the dust bag insert 10 is inserted into the sanding machine dust bag 50 and the elongated neck 30 is pulled through the collar 60 of the sanding machine dust bag 50, the elongated neck 30 is slid or extended over the exhaust pipe 100 and the collar 60 of the dust bag 50 is fastened thereto. In this way, all particulate matter 110 generated by the sanding machine 105 is filtered into the dust bag 50 via its vacuum system and caught by the dust bag insert 10.

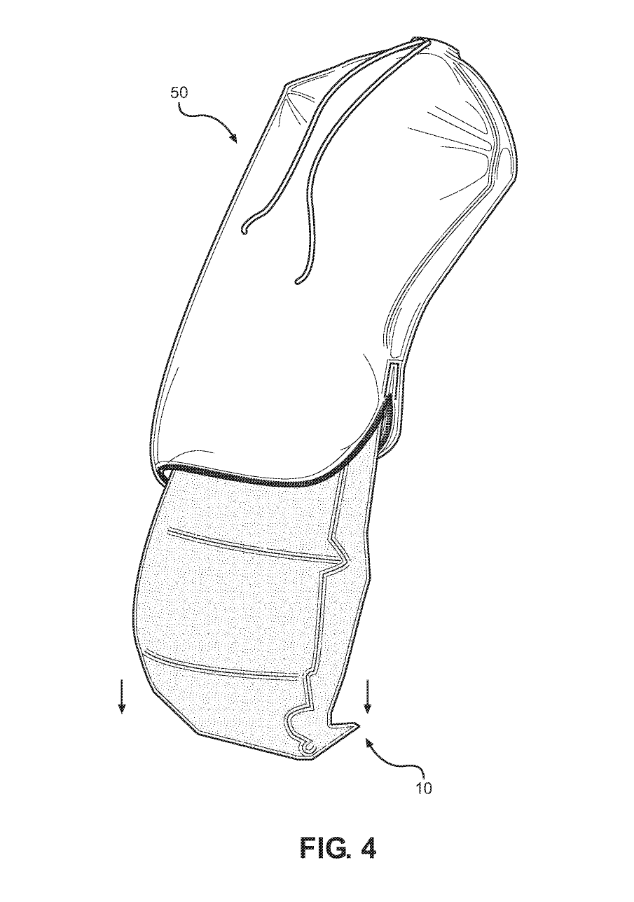

Referring now to FIG. 4, there is shown a view of the dust bag insert being removed from a conventional sanding machine dust bag. In operation, to dispose of the resultant particulate matter generated by the sanding machine, a user would remove the dust bag 50 from the sanding machine and then remove the dust bag insert 10 from the dust bag 50. In order to prevent the escape or spillage of the particulate matter caught by the dust bag insert 10, the user can tie the elongated neck of the dust bag insert 10 into a knot or seal the opening of the elongated neck by pressing opposing sides of the elongated neck together, which are then adhered together by the adhesive layer disposed on the interior surface of the elongated neck. Once closed, the dust bag insert 10 can then be removed from the dust bag 50 and discarded.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A dust bag insert, comprising:
a body including a lower end, an upper end, and an interior volume configured to receive and sustain particulate matter;
an elongated neck disposed at the upper end, the elongated neck including an opening;
wherein the body is sized and shaped to be inserted into a sanding machine dust bag;
wherein the body includes dimensions equal to a close tolerance of the dimensions of a sanding machine bag;
wherein the body is composed of a material having a porosity configured to prevent particulate matter from passing therethrough;
wherein the upper end comprises angled sides matching the shape and dimensions of a sanding machine bag;
wherein the elongated neck is sized to fit and extend through a collar of a sanding machine dust bag.

2) The dust bag insert of claim 1, wherein:
the body is further defined by a first layer and a second layer, each of the first and the second layers including edges;
wherein the edges of the first layer and the edges the second layer are joined by stitching.

3) The dust bag insert of claim 1, wherein:
the body is further defined by a first layer and a second layer, each of the first and the second layers including edges;
wherein the edges of the first layer and the second layer are joined by an adhesive.

4) The dust bag insert of claim 1, wherein the body is composed of polypropylene.

5) The dust bag insert of claim 1, wherein the elongated neck further comprises an adhesive layer disposed on an interior surface of the elongated neck.
